(19) United States
(12) Patent Application Publication
(10) Pub. No.: US 2008/0021843 A1
(43) Pub. Date: Jan. 24, 2008

(54) Method for assisting negotiation which uses a dialectic scaffolding process

(76) Inventor: Daniel Harris Patton, Eugene, OR (US)

Correspondence Address: Thomas M. Spear, Jr., P.O. Box 1274, Bend, OR, 97709-1274, US

(21) Appl. No.: 11/879,481

(22) Filed: Jul. 16, 2007

Related U.S. Application Data
(60) Provisional application No. 60/830,682, filed on Jul. 14, 2006.

(51) Int. Cl. H04L 9/00

(52) U.S. Cl. 705/80

(57) ABSTRACT

The computer implemented method for assisting in negotiations provides the necessary tools for buyers and sellers to negotiate terms of a deal in a fair and efficient manner. The method employs a dialectic scaffolding process that employs a multiplicity of channels and questions and sub-questions arranged in a decision tree wherein the responses to a question or series of questions directs the buyer or seller to reach one or more terms of a proposal. The method allows buyers and sellers to create proposals using a series of queries that are designed to provide the terms that will encompass each aspect of the transaction. The buyers and sellers have the option to take advantage of a predetermined set of queries to develop their respective proposals or they have the flexibility to modify each term of their proposal as necessary.

### CROSS REFERENCE TO RELATED APPLICATION

This application is cross referenced, related to, and claims the benefit of provisional Patent application 60/830,682. The provisional was filed on Jul. 14, 2006.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

In the marketplace, there is an ever-increasing appreciation of, and demand for, computer supported negotiation tools or models for harnessing the collective inventories of individuals to exchange goods more efficiently. Innovation for these real-time, interactive processes has fallen far behind the expanding need for such tools.

Outside of the internet, one such model for conducting a transaction is face-to-face “haggling”. Haggling is defined as “the process of negotiating the price of something (e.g. a piece of merchandise or a service) with the intent of getting a better deal than the stated price”—Wikipedia (http://en.wikipedia.org/wiki/Haggling). Haggling is deficient in that one or both parties that are haggling may not be sufficiently aware of all information or aspects to the negotiation—haggling lacks direction and structure.

One popular model used for transacting the buying and selling of goods and services is newspaper classified advertisements. Newspaper classified advertisements are impersonal and uneconomical because the party is charged a large fee regardless of whether another party buys the goods or services. A more recent trend has been for consumers to seek online negotiation processes facilitated in various websites on the internet. These e-market (electronic market) places include sites like, auction based sites or e-classified sites. Auction sites are limited as well in that they do not encompass a full-spectrum of negotiating possibilities or tools to assist the buyer or seller in facilitating a transaction. E-classified websites are being used like newspapers in that the website contains a number of links to various goods or services that are listed. Like newspapers, these e-classified sites are lacking in that buyers and sellers, while able to review a list of goods and services, have very few tools, if any, to assist in the negotiation process.

Obviously, auction sites and e-classified sites provide the opportunity for buyers to locate and sellers to list goods and services on the web and therefore the chance for a deal to be struck. However, there is little if any likelihood that the buyer or seller will initiate negotiations to obtain the goods or services for more desirable terms. E-market places do not provide a venue for allowing buyers and sellers to haggle for goods and services.

Another barrier in making transactions for goods and services is the fact that many buyers and sellers lack both the social aptitude and technical skill that would give the buyer or seller the confidence to engage in haggling. Providing an impersonal means to direct the process for generating terms to negotiate coupled with the ability to communicate remotely or discreetly would provide an efficient and valuable asset to those who desire a level playing field.

Thus, the marketplace would benefit from a tool that provides buyers and sellers a method and apparatus for generating terms for a proposal and the ability to communicate said proposal in a manner that places both buyers and sellers on a more equal footing.

### BRIEF SUMMARY OF THE INVENTION

The computer implemented method for assisting in negotiation is a process that allows parties to negotiate in a complete, thorough, and efficient manner. The process utilizes dialectic scaffolding—or a framework of interrelated queries to derive a proposal. This process is intended to mimic the concept of “haggling” over the terms of a deal using modem technologies.

### BRIEF DESCRIPTION OF SEVERAL DRAWINGS

The following drawings are submitted to assist in the explanation of the method for assisting negotiation which uses dialectic scaffolding process:

FIG. 1—diagram of an e-market place.

FIG. 2—diagram of the haggle step.

FIG. 3—diagram of a price channel.

FIG. 4—diagram of an example of an interconnected channel decision tree in dialectic scaffolding.

### DETAILED DESCRIPTION OF THE INVENTION

The invention is set forth in the claims with the preferred embodiment described in this section.

The present invention relates to the use of a user interface for enabling collaborative negotiating environments. Although certain aspects of the description involve examples relating to use in an online environment, the invention is contemplated to have utility in any type of collaborative negotiating environment.

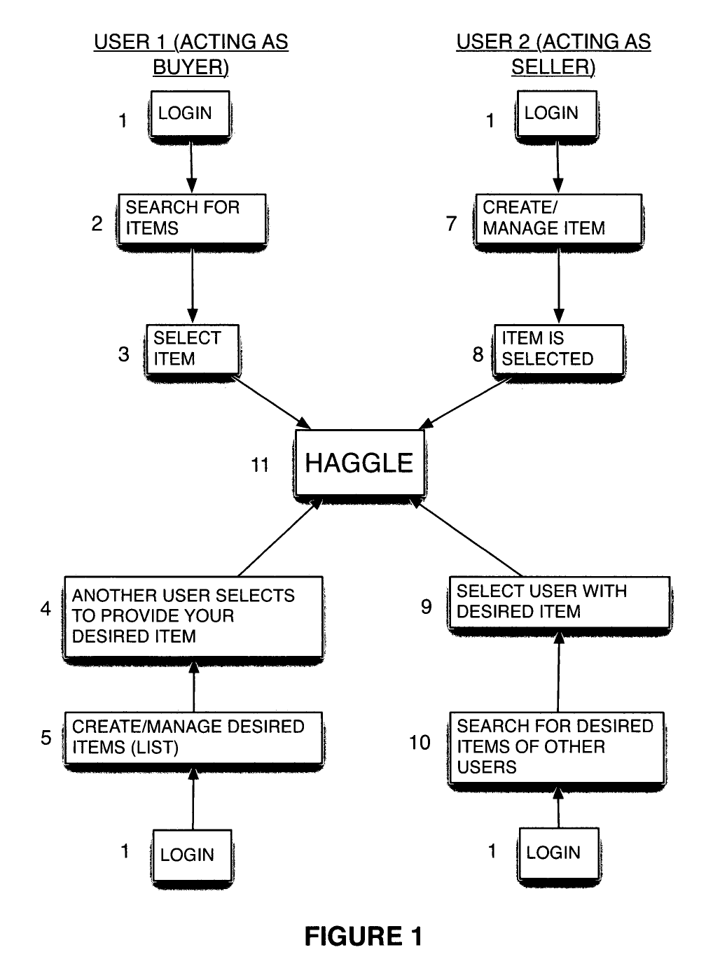

In FIG. 1, the block diagram represents a typical step-by-step process for those who utilize the internet for performing any number or type of transaction. The steps 1-10, depicted in FIG. 1, are consistent with industry standards while step 11 represents the point in the transaction at which time a proposal is sent or accepted. In the preferred embodiment, this step is replaced with a haggle step.

FIG. 1 illustrates the steps a party goes through from login (1) to haggle (11). When the party is acting as a buyer of goods or services (the buyer), the buyer can login (1), search for (2) and select from (13) a list that another party acting as a seller (the seller) who can login (1), create/manage (7) a list of goods and services to be selected by a buyer—typically, at this point the buyer and seller are in a position to negotiate or haggle (11). In the alternative, the buyer of goods or services can login (1) create/manage a list of goods or services (5) that the buyer desires and which the seller can login (1), search (10) and select (3) from the list provided by the buyer—again, the buyer and seller are in a position to negotiate or haggle (11).

In the preferred embodiment, the haggle step is a process by which the buyers and sellers generate terms for their respective proposals and communicate those proposals in a back and forth manner until the buyers and sellers can either come to an agreement, decide not to reach an agreement, or wait to complete an agreement until a later time. Note this process is not just limited to buyers and sellers but to two or more parties that have a mutual desire to negotiate terms of an agreement, for example, bartering and borrowing. However for the purposes of providing a description to the process, the embodiment described herein is one in which the parties are buyers and sellers.

The haggle step uses a process called dialectic scaffolding to create, modify, or delete terms of the proposals. The dialectic scaffolding process is one in which one or both parties to a negotiation, while being assisted by a computer, are better able to determine and generate one or more terms of a proposal. Dialectic, from classical Greek philosophy, “is an exchange of propositions (theses) and counter-propositions (antitheses) resulting in a synthesis of the opposing assertions, or at least a qualitative transformation in the direction of the dialogue”, Wikipedia (http://en.wikipedia.org/wiki/Dialectic). Scaffolding in this context is the framework that supports the process—in this case a channel and supported by a series of questions and sub-questions arranged in a decision tree. The series of questions, or decision tree, are arranged in a manner that provides a logical basis for reaching a particular term of the proposal. The channels and the series of questions arranged in a decision trees, called levels, are either predetermined or determined by the party depending on the particular transaction being negotiated. Predetermined channels and levels are provided by industry standards and practices. The usefulness or efficiency of the dialectic scaffolding process is enhanced by arranging the channels and levels such that the levels and channels are interconnected in such that the current channel and level in which the party is accessing and answering will be processed throughout the other channels and levels to clarify or correct previous responses or anticipate future responses.

This means the party using the process of dialectic scaffolding benefits from the fact that as the party responds to queries in one channel for generating one term of the proposal, those responses are being processed throughout all the channels and levels of the dialectic scaffold, causing each term of the proposal to be impacted and current. This results in the party using the dialectic scaffolding process to benefit from use of a dynamic process instead of a static one.

FIG. 1, step 1 depicts the user login by the buyer or seller. Typically, login (1) allows access to a user account and the option to search for goods or services for sale or list goods or services to be sold. A buyer or seller can simultaneously buy and sell goods and services in different transactions. In this preferred embodiment, the buyers and sellers can conduct unlimited separate transactions with other parties who are acting as buyers or sellers for goods and services.

At any point while searching for goods or services, the buyer or seller can prepare to haggle (11) with another party if a desired good or service is located. If a good or service cannot be located the buyer or seller can add the desired item to their respective lists (5) & (7). Once a buyer or seller has made the decision to select (3) or (9) another item from a list of goods or services, the buyer or seller can then haggle (11).

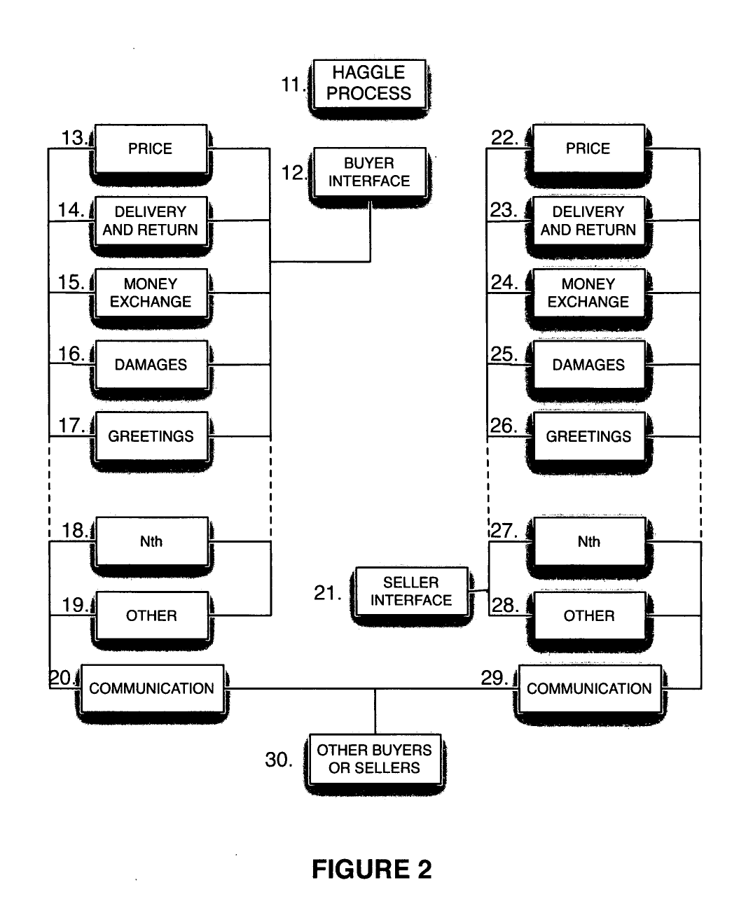

The basic structure of one type of haggle process is depicted in FIG. 2. This particular embodiment of the haggle step for a buyer (1) depicts a negotiation process for goods or services with several channels that are labeled; price (13), delivery & return (14), money exchange (15), damages (16), and greetings (17). The seller (21) has the same channels for this particular haggle and they are labeled price (22), delivery & return (23), money exchange (24), damages (25), and greetings (26).

The buyer and seller can also create additional channels as depicted by the dotted line down to the nth channel (18) if they so desire. For this particular embodiment, the channels might represent terms to be used for the transactions of goods or services. It should be pointed out that in the preferred embodiment of the invention, the buyer or seller is able to select from predetermined channels or they can add, modify, and eliminate channels in order to assist the buyer or seller in reaching a completed agreement and is discussed later.

In FIG. 2, two other channels are associated with both the buyer and seller. These channels are the OTHER function channel [(19) and (28)] and the COMMUNICATION function channel [(20) and (29)]. Block 30 in FIG. 2 represents the lines of communication to other buyers and sellers, for example on the internet where the parties are communicating through a particular website.

One of the preferred embodiments of the invention provides an OTHER function channel for the buyer and seller. The OTHER function channel is the means by which a buyer or seller can create, modify, or delete channels or levels. The OTHER function channel provides the buyer or seller with at least one of the following functions, including: adding, modifying, or eliminating a channel or levels; on demand; back to & forward to; and hide the channels/level. Once logged in, the buyer or seller has the OTHER function channel available at all times.

The “adding, modifying, or eliminating a channel or level” function provides the buyer or seller with the option to create, modify, or eliminate a channel or level when necessary.

The “on demand” function allows the buyer or seller to control when the dialectic scaffolding process is to be used. The buyer or seller can opt to use the scaffolding or have it present and not use it.

The “back to & forward to” function allows the buyer or seller to go back and forth between channels and either down or up levels in each channel.

The hide the channel/levels function allows the buyer or seller to keep their channels and levels hidden as needed.

The OTHER function channel provides the flexibility necessary in the haggling process to enable buyers and sellers to reach a complete agreement on all terms of the proposal.

The COMMUNICATION function channel, like the OTHER function channel, is available to the buyer or seller at any time. The COMMUNICATION function channel has at least one of the following functions available, including: list a term, send a term, satisfied with a term, not satisfied with a term, generate a counter to a term received, wait until all terms generated. The COMMUNICATION function channel provides the means for a buyer or seller to communicate to one or more buyers or sellers.

The “list a term” function provides a means for the buyer or seller to list one or more terms or a complete proposal for goods and services.

The “send a term” function is a means to send one, several, or a complete proposal for consideration to one or more other buyers or sellers.

The “not satisfied with a term” function provides a means for the buyer or seller to communicate dissatisfaction with a term listed or sent by another buyer or seller.

The “generate a counter to a term” function provides a means to create a counter term or counter proposal upon receipt of a term or proposal.

The “wait until all terms generated” function allows the receiver of a term or terms to communicate that a completed proposal is needed prior to a response from the receiver.

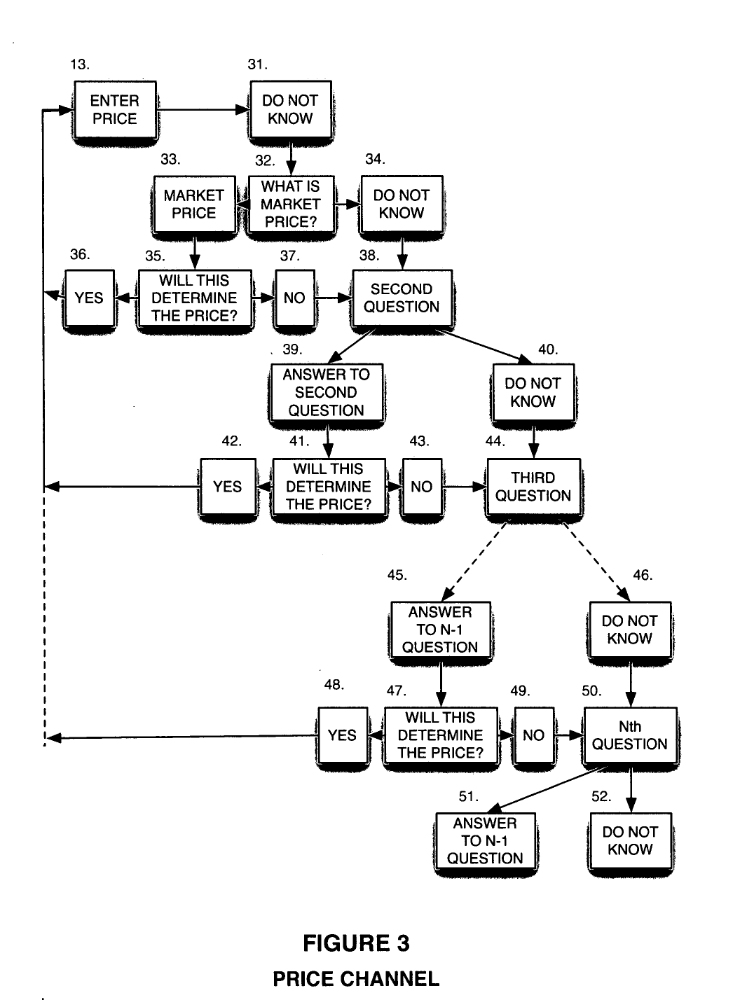

In FIG. 2, the price channel (13) is further depicted in FIG. 3. In FIG. 3, the price channel depicts one embodiment for the dialectic scaffolding process. In the price channel, the buyer or seller is provided with several plausible pathways to reach price, one term of a proposal. The process for determining price in FIG. 3 depicts the buyer or seller having the option to access several levels of the channel in order to determine price. The buyer or seller is directed through the levels by responding to a series of queries that is designed to assist the buyer or seller in formulating the proper term for the channel. The levels, like the channels, are either predetermined by the buyer or seller or the levels can be added, modified, or eliminated by either the buyer or seller using the OTHER function channel. The response to a question at each level can be automatically processed throughout some or all of the channels (and their levels) so as to provide a dynamic updating to the various channels. Individual channels are interconnected in the sense that the decision tree pathway in one channel might affect the decision tree pathways in other channels.

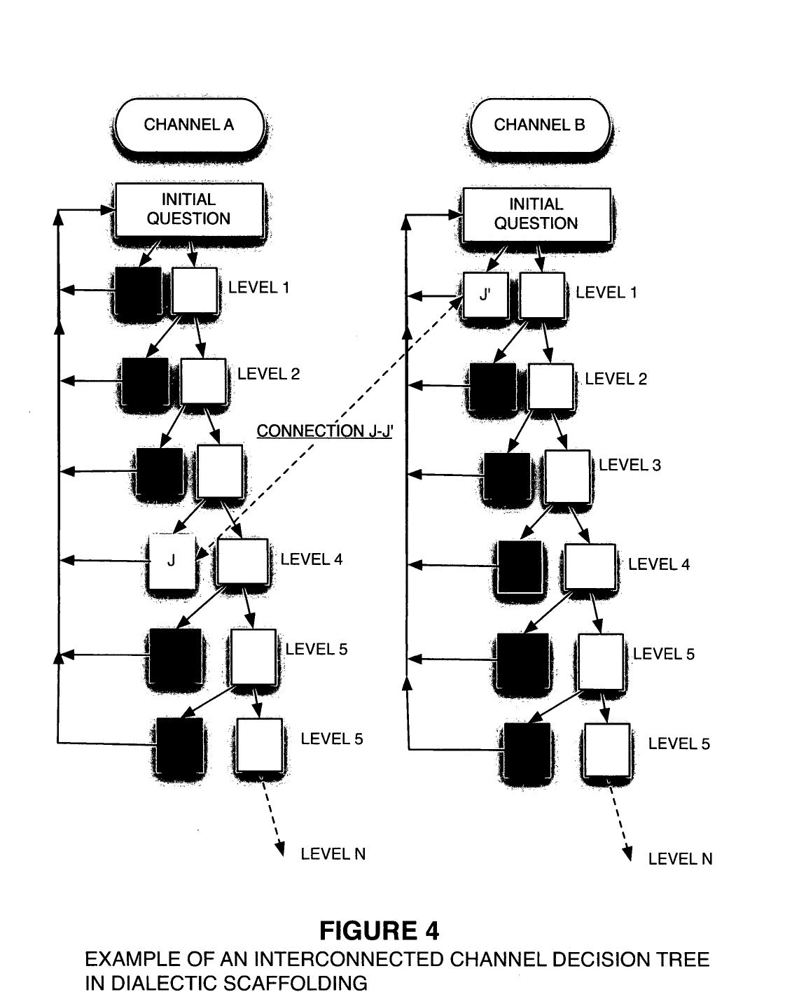

FIG. 4 provides an example of a channel and the levels that represents the multiplicity of questions and sub-questions arranged in a decision tree. When the buyer or seller is on a particular level, the current level, the question being addressed at that level will be connected to other levels within other channels such that a response will update all other levels and channels to make them current. In FIG. 4 the black boxes signifies an affirmative answer to the question posed at that level. Affirmative answers will lead to the channel requirement being met. A white box represents a negative answer to a question. A negative answer in this example leads the buyer or seller to lower levels and more questions. The questions are meant to provide a better understanding of the initial question, or the term for the proposal. In FIG. 3 on Channel A level 4, the affirmative answer is J. This answer is then processed through the other channels such that the first level in the B channel is also answered at the same time, J′. Adjusting values in one channel influences the other channels if there is a difference in responses to the same questions. This means the channels and the terms are constantly kept current and updated.

When a buyer or seller provides information about a specific term in one channel, that information can be processed through all other channels. There is a constant interplay between the channels to assist the buyer or seller understand the relationship between each channel and therefore all the aspects of the negotiation. This provides the buyer or seller with a current and updated set of responses for all channels and levels that have the same or similar questions. The proposal and the terms are therefore current with each question the buyer or seller answers.

For example, if a buyer or seller uses the dialectic scaffolding process to determine price, FIG. 3, and the buyer or seller reaches the level in which the query is Question 3 and for this example the question is “How often do you use the Item?” (44) and the buyer or seller provides the answer “Frequently” [for this example, Frequently is an option from Frequently, Rarely, Never, I do not know]—then this response can be processed throughout all the other channels.

Responses to queries are typically made by selecting between two or more choices, depending on the type of question. Again, queries and the response to said queries can be predetermined or determined by the buyer or seller using the OTHER function channel.

The “Frequently” response for “how often do you use the Item?” question—will impact other channels where timing for the use of the goods or services becomes important, like the channel “Delivery & Return” (14) or (23) in FIG. 2—where it is likely this channel would have a level in which there is a query “How often do you use the Item?”. Any response to a query in the channels and level can impact the various terms of the proposal.

It should be noted that in the dialectic scaffolding process, the buyer or seller is directed to lower and lower levels of a channel in order to provide sufficient information for the buyer or seller to determine the term being sought. A lower level is typically reached when the response to a query might be “no” or “I don't know”. Once the buyer or seller has sufficient information to adequately provide the term—the buyer or seller can choose to input that term. This fulfills the channel and the buyer or seller can then move to another channel to determine another term or communicate the term or proposal to the other party.

It should be noted that both the buyer and seller have access to the dialectic scaffolding process for each term in the proposal and the dialectic scaffolding process can be initiated at any time the buyer or seller has logged in and is searching or listing goods or services. Terms, or channels and their levels, can be predetermined or determined by the buyer or seller accessing the dialectic scaffolding. Buyers and sellers can also use predetermined queries in newly created channels or some combination of creating new channels and new levels with predetermined channels and levels.

A predetermined channel or level is one in which the particular embodiment of the haggle process utilizes common standards generally found in that particular area of commerce. For example; the buying and selling of real estate where industry practice has a number of terms that are typically found in a real estate contracts would be available for the buyer or seller to use as needed. This does not preclude those who utilize the haggle process in one particular area of commerce from creating, modifying, or eliminating terms as needed.

After the buyer or seller has completed the price channel, the dialectic scaffolding process can direct the buyer or seller to other terms of the proposal. The other terms depicted in FIG. 2, include: delivery and return (14), money exchange (15), damages (16), and a greeting channel (17). The buyer or seller can communicate and haggle over one, several, or all terms of the proposal. The buyer or seller can communicate at any time one, several, or all terms of the proposal through use of the COMMUNICATION function channel.

Another aspect of the preferred embodiment includes the ability of buyers and sellers to remotely communicate with other buyers and sellers at a website dedicated to utilizing the haggle step. In this site, buyers and sellers are able to focus their efforts, maintain anonymity; and efficiently complete negotiations. It is a preferred embodiment for this invention to maintain a site where the buyers and sellers are able to login, access a list of goods or services, search through the desired list of goods and services enter into negotiations with others by haggling. Buyers and sellers are able to direct their searches to goods and services that they know are available and can be negotiated for by haggling. By knowing that other buyer and sellers are listing their goods and services in this particular site—buyers and sellers are prepared to negotiate using the haggle process.

The site also provides a means by which buyers and sellers are able to maintain their anonymity by selecting a user name after logging into the site. A user name allows the buyer or seller to minimize concerns that others will use the identity of the buyer or seller as an advantage during the negotiations.

We claim:

1. A computer implemented method for assisting negotiations between two or more parties, comprising:
storing a system for assisting negotiations which utilizes a dialectic scaffolding process in a storage device in a computer system, wherein the dialectic scaffolding process includes a number of plausible pathways for generating one or more terms of a proposal; wherein the number of plausible pathways includes a multiplicity of channels wherein each channel may contain a multiplicity of questions and sub-questions arranged in a decision tree in which a response to a question or sub-question may influence or become one or more terms of the proposal or will direct the party to additional questions within the decision tree with each answer providing a logical framework for defining the term or terms of the proposal.
providing a means for a first party to interface with the dialectic scaffolding in order to create one or more terms of the proposal;
providing a means of storing, accessing, and communicating the proposal to other parties;
providing a means for a second party to either accept the term or terms of the proposal or to access and utilize the dialectic scaffolding process to create a counter-proposal;
providing a means to store, access, modify, and communicate the counter-proposals to the first party
whereby the first party can either accept the term or terms of the counter-proposal or continue to negotiate utilizing the dialectic scaffolding process.

2. The computer implemented method for assisting negotiations of claim 1, wherein the multiple channels and various questions in the decision tree can be predetermined or user-determined.

3. The computer implemented method for aiding and assisting negotiations of claim 1, wherein the response to a current question within one decision tree of an individual channel may be processed throughout all other channels and decision trees, such that other questions in other channels and decisions trees that are the same or similar to the current question will be updated with the response to the current question.

4. The computer implemented method for assisting negotiations of claim 1, wherein at least one channel in the multiplicity of channels is a designated an “OTHER function” channel that provides at least one of the following functions; adding, modifying, or eliminating a channel or level, on demand, back to & forward to, and hide the channel/levels function.

5. The computer implemented method for assisting negotiations of claim 1, wherein at least one channel in the multiplicity of channels is a designated a “COMMUNICATION function” channel that provides at least one of the following functions; list a term, send a term, not satisfied with a term, generate a counter to a term, and wait until all terms generated function.

6. The computer implemented method for assisting negotiations of claim 1 wherein the dialectic scaffolding contains plausible pathways for the negotiation of real property, wherein at least one of the channels will include; price, closing date, earnest money, inspections, appraisals, down payment, financing options, time or possession, and appliances.

7. The computer implemented method for assisting negotiations of claim 1 wherein the dialectic scaffolding contains plausible pathways for the negotiation for loans, mortgages, and financial proposals, debt consolidation, wherein at least one of the channels include; interest rate, amount financed, prepayment penalties, variable/fixed rate, and collateral.

8. The computer implemented method for assisting negotiations of claim 1 wherein the dialectic scaffolding contains plausible pathways for the negotiation for business purchase and sale, wherein at least one of the channels include; price, financing option, property and equipment included, escrow, and appraisals.

9. The computer implemented method for assisting negotiations of claim 1 wherein the dialectic scaffolding contains plausible pathways for the negotiation to purchase a business, wherein at least one of the channels include; price, financing option, property and equipment included, escrow, and appraisals.

10. The computer implemented method for assisting negotiations of claim 1 wherein the dialectic scaffolding contains plausible pathways for the negotiation for rental or lease property, wherein the at least one of the channels would include; delivery and return, schedule of use, money exchange, and damages.

11. The computer implemented method for assisting negotiations of claim 1 wherein the dialectic scaffolding contains plausible pathways for the negotiation for professional services, wherein at least one of the channels would include; services to be performed, compensation, and money exchange.

12. The computer implemented method for assisting negotiations of claim 1 wherein the party interfaces with the dialectic scaffolding process through remote access by means of a computer and an internet connection.

13. The computer implemented method for assisting negotiations of claim 1 wherein the parties are able to remain anonymous during negotiations.

14. A system comprising: a data storage device, processors, hardware, software, and internet connections to support remote access for utilizing the computer implemented method for assisting negotiations.
